(19) United States
(12) Patent Application Publication
(10) Pub. No.: US 2026/0172857 A1
(43) Pub. Date: Jun. 18, 2026

(54) RRM Measurements for UE Supporting BWP Without Restriction

(71) Applicant: Apple Inc., Cupertino, CA (US)

(72) Inventors: Qiming Li, Beijing (CN); Yuexia Song, Beijing (CN); Dawei Zhang, Saratoga, CA (US); Jie Cui, San Jose, CA (US); Yang Tang, San Jose, CA (US); Manasa Raghavan, Sunnyvale, CA (US)

(21) Appl. No.: 18/851,647

(22) PCT Filed: Sep. 26, 2023
(86) PCT No.: PCT/CN2023/121349

§ 371 Date: Sep. 26, 2024

(51) Int. Cl. H04W 24/08

(52) U.S. Cl. CPC H04W 24/08

(57) ABSTRACT

A next generation node B (gNB) configured to decode, from signaling received from a user equipment (UE), an indication that the UE is capable to periodically change an actual bandwidth (BW) of the UE within a channel bandwidth (CBW) to include an active bandwidth part (BWP) and a bandwidth of a target Synchronization Signal Block (SSB) of the gNB located in the CBW and outside the active BWP of the UE; determine, based on at least the indication, that the UE supports a no-gap measurement for an intra-frequency measurement of the target SSB; and encode, for transmission to the UE, one or more downlink signals to enable the UE to perform measurements of the target SSB with no-gap.

### FIELD

Embodiments of the invention relate to wireless communications, including apparatuses, systems, and methods for radio resource management (RRM) measurement for user equipment (UE) supporting bandwidth part (BWP) without restriction in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

Bandwidth Part (BWP) without restriction (e.g., bwp-WithoutRestriction) was introduced in Rel-15 of the 3GPP standards as an optional feature. A UE that supports this feature indicates support of BWP operation without bandwidth restriction. The bandwidth restriction in terms of downlink (DL) BWP for a Primary Cell (PCell) and Primary Secondary Cell (PSCell) means that the bandwidth of a UE-specific Radio Resource Control (RRC) configured DL BWP may not include the bandwidth of Core Resource Set (CORESET) #0 (if configured) and the Synchronization Signal Block (SSB). For Secondary Cells (SCells), it means that the bandwidth of DL BWP may not include the SSB.

In addition, feature 6-1a was introduced in Rel-15 of the 3GPP standards as an optional feature. A UE that supports this feature has a component that bandwidth (BW) of UE-specific radio resource control (RRC) configured bandwidth part (BWP) may not include BW of the CORESET #0 (if present) and SSB for PCell/PSCELL (if configured) and BW of the UE-specific RRC configured BWP may not include SSB for SCell.

However, the specification support for this feature is not yet fully complete. For example, by the end of Rel-17 of the 3GPP standards, Radio Resource Management (RRM) requirements of Radio Link Monitoring (RLM), Beam Management (BM) and Beam Failure Detection (BFD) are applicable only if the associated reference signal (RS) is within an active BWP for the UE. Thus, there are additional details that need to be defined to fully support the BWP without restriction feature.

### SUMMARY

Embodiments relate to wireless communications, and more particularly to apparatuses, systems, and methods for an apparatus of a next generation node B (gNB) that comprises one or more processors configured to decode, from signaling received from a user equipment (UE), an indication that the UE is capable to periodically change an actual bandwidth (BW) of the UE within a channel bandwidth (CBW) to include an active bandwidth part (BWP) and a bandwidth of a target Synchronization Signal Block (SSB) of the gNB located in the CBW and outside the active BWP of the UE; determine, based on at least the indication, that the UE supports a no-gap measurement for an intra-frequency measurement of the target SSB; and encode, for transmission to the UE, one or more downlink signals to enable the UE to perform measurements of the target SSB with no-gap, and a memory coupled to the one or more processors.

Other embodiments relate to an apparatus of a next generation node B (gNB), the apparatus comprising one or more processors configured to decode, from signaling received from a user equipment (UE), an indication that the UE supports inter-frequency no-gap and no-interruption measurement for measurement of a target Synchronization Signal Block (SSB) of the gNB; determine, based on at least the indication, that the UE supports changing an actual bandwidth (BW) of the UE to match a channel bandwidth (CBW) that includes an active bandwidth part (BWP) and a bandwidth of the target SSB located in the CBW and outside the active BWP of the UE; and encode, for transmission to the UE, one or more downlink signals to enable the UE to perform measurements of the target SSB with no-gap and no-interruption, and a memory coupled to the one or more processor.

Other embodiments relate to an apparatus of a next generation node B (gNB), the apparatus comprising one or more processors configured to decode, from signaling received from a user equipment (UE), an indication that the UE is capable to periodically change an actual bandwidth (BW) of the UE within a channel bandwidth (CBW) to include an active bandwidth part (BWP) and a bandwidth of a target Synchronization Signal Block (SSB) of the gNB located in the CBW and outside the active BWP of the UE; determine, based on at least the indication, that the UE supports a no-gap measurement for an inter-frequency measurement of the target SSB; and encode, for transmission to the UE, one or more downlink signals to enable the UE to perform measurements of the target SSB with no-gap, and a memory coupled to the one or more processors

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates an example schematic bandwidth diagram in the frequency domain according to some embodiments.

FIG. 9 illustrates an example schematic bandwidth diagram in the frequency domain according to some embodiments.

FIG. 10 illustrates a method for determining a measurement gap configuration for RRM measurements according to some embodiments.

FIG. 11 illustrates another method for determining a measurement gap configuration for RRM measurements according to some embodiments.

FIG. 12 illustrates another method for determining a measurement gap configuration for RRM measurements according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1(FR1 ) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non- 3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to configuring intra-frequency and inter-frequency RRM measurement for UEs supporting bandwidth part (BWP) without restriction.

The example embodiments are described with regard to communication between a next generation Node B (gNB) and a user equipment (UE). However, reference to a gNB or a UE is merely provided for illustrative purposes. The example embodiments may be utilized with any electronic component that may establish a connection to a network and is configured with the hardware, software, and/or firmware to support gapless RRM measurements. Therefore, the gNB or UE as described herein is used to represent any appropriate type of electronic component.

The example embodiments are also described with regard to a fifth generation (5G) New Radio (NR) network that may configure a UE to perform measurements of a target SSB with no-gap and with-interruption, or no-gap and no-interruption. However, reference to a 5G NR network is merely provided for illustrative purposes. The example embodiments may be utilized with any appropriate type of network.

Throughout this description various information elements (IEs) are referred to by specific names. It should be understood that these names are only examples and the IEs carrying the information referred to throughout this description may be referred to by other names by various entities.

As described above, there are various aspects of features that still need to be defined. One option to support RLM/BM/BFD when the SSB configured for layer 1 (L1) operation is outside an active BWP of the UE is to use a larger bandwidth to cover the target SSB and the UE active BWP. This option is colloquially referred to as B-1-1 and that terminology will be used throughout this description in reference to this option. However, it should be understood that this option may be referred to using different terminology, e.g., when adopted into the 3GPP standards. A new UE capability may be introduced to indicate support for the B-1-1 option and throughout this disclosure this will be referred to as UE capability B-1-1. However, it should again be understood that this UE capability may be referred to using different terminology. A typical implementation of the B-1-1 option is that UE would set the actual bandwidth as large as the channel bandwidth (CBW).

Another option to support RLM/BM/BFD when the SSB configured for layer 1 (L1) operation is outside an active BWP of the UE is to selectively and periodically use a larger bandwidth at the UE to cover the target SSB and the UE active BWP, and otherwise reduce the bandwidth. This option is colloquially referred to as B-1-2 and that terminology will be used throughout this description in reference to this option. However, it should be understood that this option may be referred to using different terminology, e.g., when adopted into the 3GPP standards. A new UE capability may be introduced to indicate support for the B-1-2 option and throughout this disclosure this will be referred to as UE capability B-1-2. However, it should again be understood that this UE capability may be referred to using different terminology. A typical implementation of the B-1-2 to enlarge the BW at the UE to cover the SSB on SSB occasions, and keep the BW set to cover the active BWP before and after the SSB occasion.

In addition to RLM/BM/BFD, the UE may also perform other RRM measurements for mobility purposes, e.g., handover, Carrier Aggregation (CA)/Dual Connectivity (DC) management, etc. In legacy operation (e.g., Rel-15), when the target SSB configured for RRM measurement is outside the active BWP for the UE, the network has to configure a measurement gap for the UE to conduct the measurements. During the measurement gap, the UE can tune its radio frequency (RF) circuitry away from the active BWP to cover the target SSB. Thus, in this scenario, the UE cannot be scheduled during the measurement gap.

A UE that supports B-1-1 or B-1-2, should be able to conduct RRM measurements on target SSBs without a measurement gap even if the SSB is outside the actual BW of the UE, e.g., because the UE would set the actual BW as large as the CBW or because the UE would temporarily enlarge the actual BW to cover the target SSB and the UE active BWP. There are existing UE capabilities to indicate support of gapless RRM measurements, e.g., NeedForGaps and network controlled small gap (NCSG). However, there is no dependency between B-1-1 or B-1-2 and NeedForGaps/NCSG. In addition, UE feedback of NeedForGaps and NCSG is based on a network inquiry and some networks do not implement NeedForGaps and NCSG. Thus, these types of networks cannot know if a UE needs a measurement gap for RRM measurements in this scenario. Throughout this description, the terms “no-gap,” “gapless,” “without a measurement gap” or “no measurement gap” should be understood to indicate that the UE has the capability of and/or is configured to perform measurements of a target SSB without having to tune the UE away from the frequency the UE is currently monitoring, e.g., no measurement gap is used for the measurements of the target SSB.

The example embodiments provide various manners for a network to determine whether a UE supports gapless RRM measurements. The determination may be based on a dependency between different categories or types of RRM measurements that the UE may be configured to perform. The example embodiments are described in greater detail below.

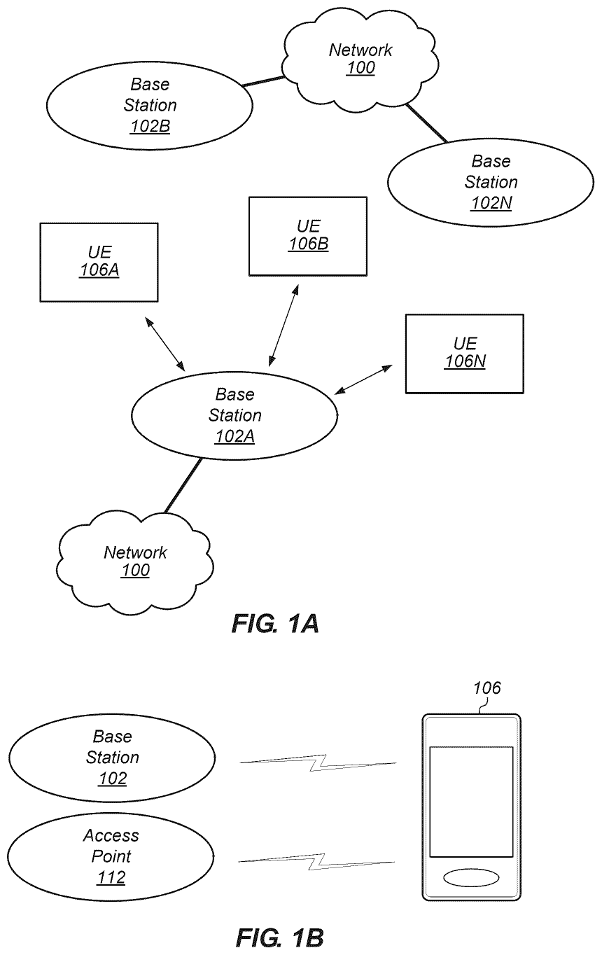

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

In some embodiments, the base stations 102 can be configured for inter-band SSB-less carrier aggregation, as further described herein. One base station 102A may be a primary cell (PCell) with a radio resource control (RRC) connection, while another base station 102N may be a secondary cell (SCell) that is configured for inter-band and non-contiguous communication without a synchronization signal block (SSB-less).

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

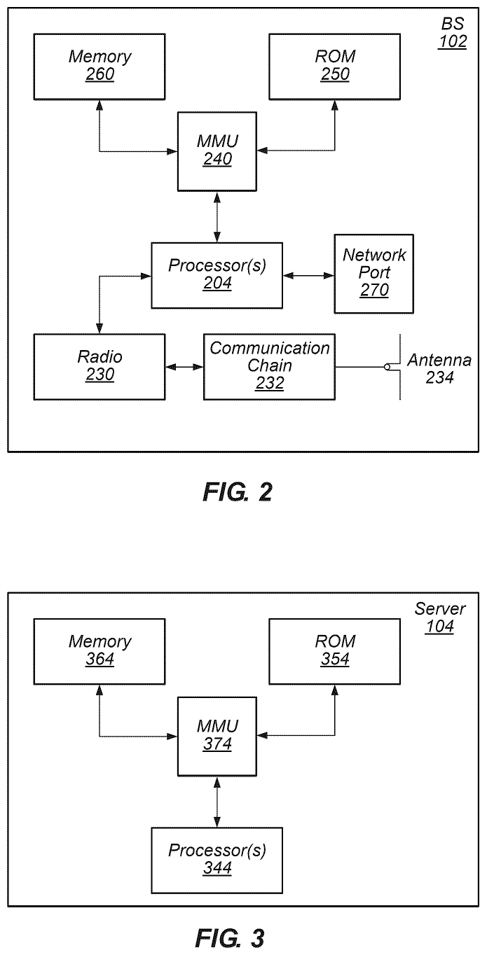

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station or gNB 102, and/or processors 204 thereof, can be capable of and configured to decode indications from the UE 106, determine UE capabilities based on the indications, and encode for transmission to the UE 106 downlink signals to enable the UE to perform measurements of the target SSB with no-gap and with-interruption, or with no-gap and no-interruption.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

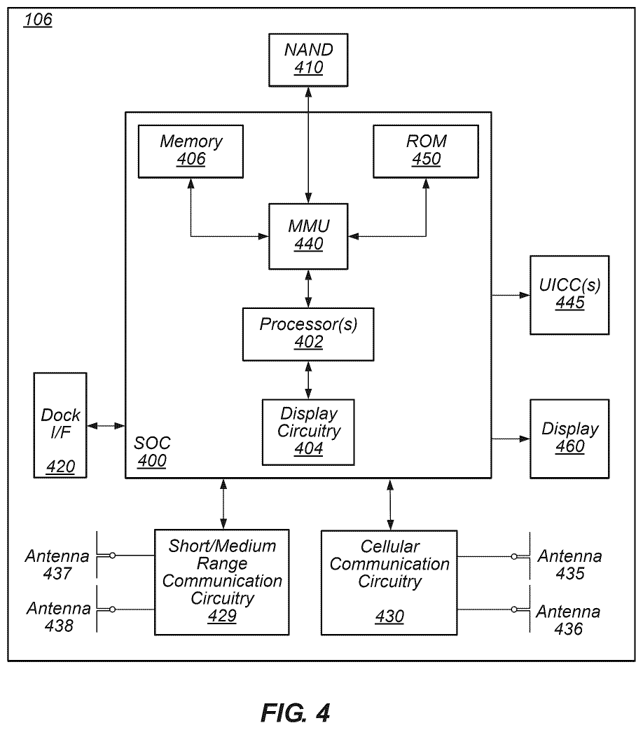

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMS may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VOLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 and processors 402 can be configured to and/or capable of performing various operations related to reporting a UE capability for intra-frequency B-1-2 operations, inter-frequency B-1-1 operations, inter-frequency B-1-2 operations, change an actual BW to match CBW (B-1-1 operation), occasional change an actual BW to include a target SSB (B-1-2 operation), intra-frequency measurement with no-gap and with-interruption, inter-frequency measurement with no-gap and no-interruption, and/or inter-frequency measurement with no-gap and with-interruption, as described herein.

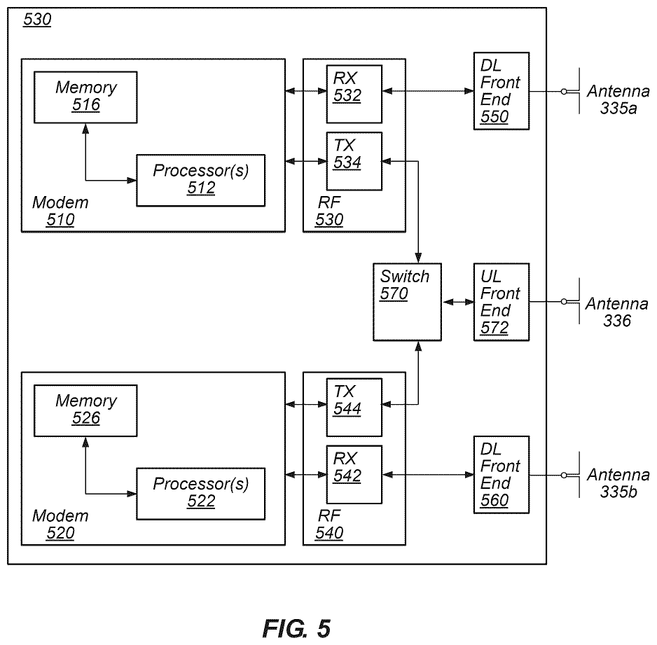

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

In some embodiments, the processors 512, 522 can be configured for inter-band SSB-less carrier aggregation, as further described herein.

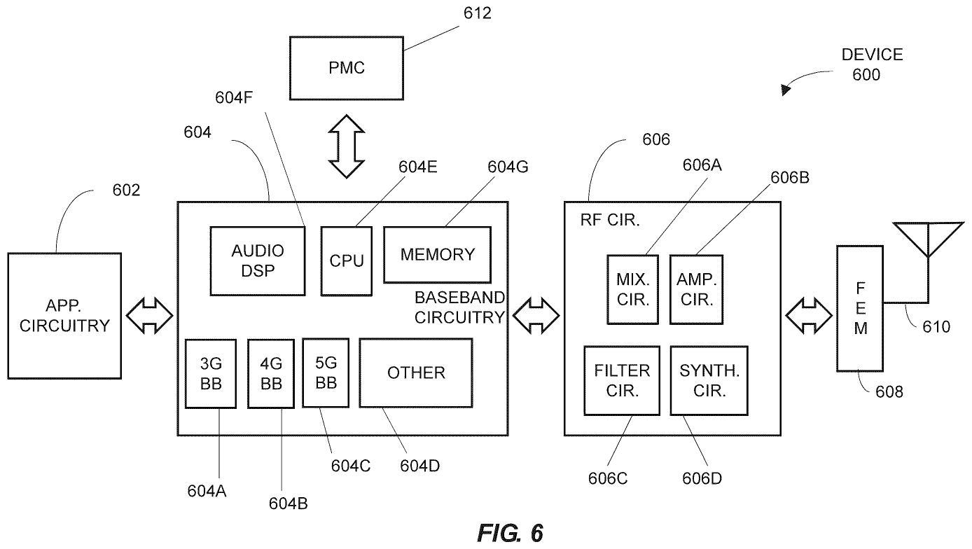

### FIG. 6: Block Diagram of a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuity 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in an RRC_Connected state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it will transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below. Accordingly, the baseband circuitry 604 can be used to encode a message for transmission between a UE and a gNB, or decode a message received between a UE and a gNB.

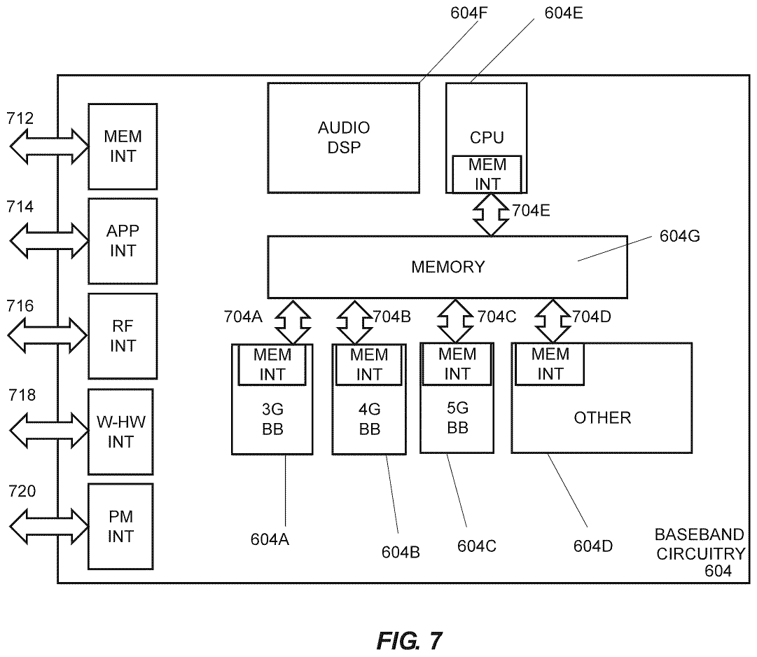

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 7914 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

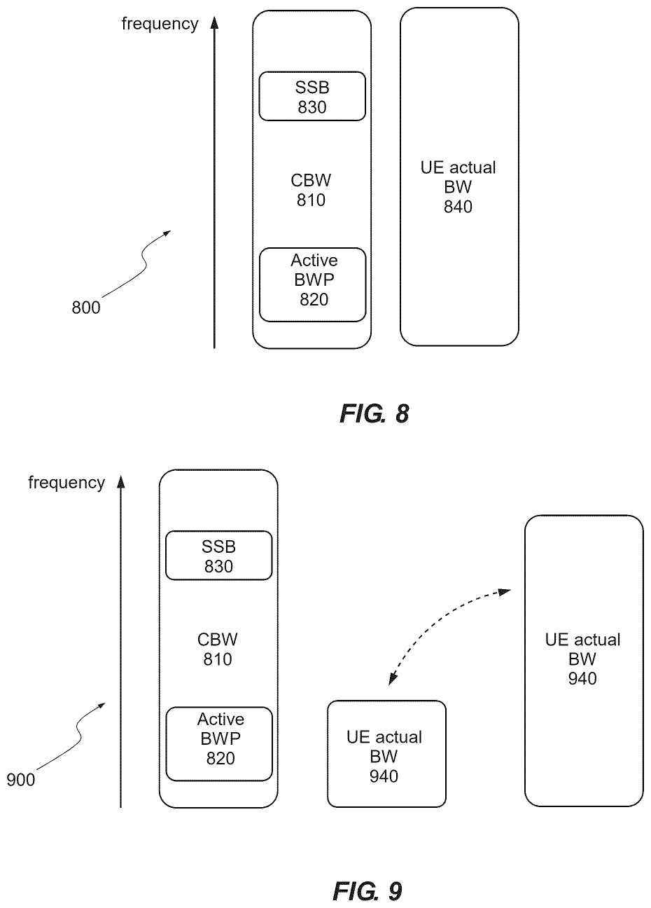

### FIGS. 8 and 9: Schematic Bandwidth Diagram in the Frequency Domain

FIGS. 8 and 9 are an illustration of bandwidth diagrams 800 and 900 in the frequency domain according to some example embodiments. In this example, it may be considered that the bandwidth diagram 800 or 900 is illustrating a downlink (DL) bandwidth on which the gNB 102 is transmitting and the UE 106 is receiving. However, an uplink (UL) diagram would be similar to the DL bandwidth diagram 800 or 900, except that the UE 106 would be transmitting on the UL frequencies and the gNB 102 would be receiving. In addition, the types of signals transmitted/received in the DL and UL may be different.

Initially, the bandwidth diagrams 800 and 900 show a CBW 810. Typically, in 5G networks, the CBW is a maximum transmission bandwidth (defined in terms of resource blocks (RBs) and guard bands on both ends of the frequency spectrum (with the guard bands defined in terms of (kilohertz) kHz). However, the CBW 810 may be any group of contiguous frequencies. An active BWP 820 frequency is defined within the CBW 810. The active BWP 820 is a set of contiguous frequencies within the CBW 810 that is configured for the UE 106. Multiple UEs may be configured with the same active BWP 820. The UE 106 is configured to receive Physical Downlink Shared Channel (PDSCH) transmissions, Physical Downlink Control Channel (PDCCH) transmissions, Channel State Information Reference Signals (CSI-RS), and Tracking Reference Signals (TRS) in the configured active BWP 820. Another manner of stating this is that the UE 106 does not expect to receive these signals outside of the active BWP 820.

Furthermore, an SSB 830 frequency is defined within the CBW 810. Multiple SSBs may be configured for a UE. The example embodiments described herein may be related to an SSB configured for layer 1 (L1) operations, e.g., RRM measurements, and the SSB 830 may be considered to be this type of SSB. As shown in FIGS. 8 and 9, the SSB 830 is outside the frequency range of the active BWP 820 of the UE 106. As shown in FIG. 8, when option B-1-1 is implemented, the UE 106 may use a larger bandwidth, e.g. a UE actual BW 840, to cover the target SSB (e.g., SSB 830) and the UE active BWP 820. The UE actual BW 840 may be set to be the frequency range of the CBW 810. As shown in FIG. 9, when option B-1-2 is implemented, the UE 106 may periodically change the UE actual BW 940 to use a larger bandwidth, e.g. increase the UE actual BW 940, to cover the target SSB (e.g., SSB 830) and the UE active BWP 820. The UE can then change the UE actual BW 940 to use a smaller bandwidth, e.g. decrease the UE actual BW 940, to a frequency range that includes the active BWP 820 and excludes the target SSB 830. Reducing the UE actual bandwidth can significantly reduce power consumption at the UE.

When the SSB is within the UE actual BW 840, 940, then the UE can perform measurements on the SSB 830 while also communicating with the active BWP 820. Because the UE 106 may use the larger bandwidth when implementing option B-1-1, the UE 106 may not need to tune away (e.g., no measurement gap, also referred to as no-gap), and may not need interruption (e.g., not have a measurement interruption, also referred to as no-interruption), to perform intra-frequency or inter-frequency RRM measurements on the SSB 830 when it is located in a frequency range that is outside of the frequency range of the active BWP 820. In addition, because the UE 106 may periodically or occasionally switch the UE actual bandwidth between larger and smaller bandwidths when implementing option B-1-2, as illustrated in FIG. 9, the UE 106 may not need to tune away (e.g., not have a measurement gap, or no-gap), but may need an interruption (e.g. have a measurement interruption or with-interruption), to perform intra-frequency or inter-frequency RRM measurements on the SSB 830 that is outside the active BWP 820.

However, the UE 106 may not have a mechanism to indicate this capability to the network such that the network understands that it does not need to configure a measurement gap or interruption for the UE 106 when operating in accordance with option B-1-1, or does not need to configure a measurement gap but an interruption when operating in accordance with option B-1-2. The interruption may be used to allow a radio to change frequencies for inter-frequency measurements. The example embodiments described herein provide various methods of notifying the network that the UE 106 does not need to configure a measurement gap or interruption in the B-1-1 scenario, and does not need to configure a measurement gap but does need to configure an interruption in the B-1-2 scenario, e.g., intra-frequency or inter-frequency RRM measurements.

Currently, information elements (IEs) are used to identify whether a UE needs a gap to measure a target SSB. One IE is called NeedForGaps. The UE can indicate whether the UE needs a gap, or no gap using the IE, to measure a target SSB. Alternatively, the network or gNB can use a similar information element, called network controlled small gap (NCSG), in which the network can signal a gap period for a UE, if a gap is necessary for the UE to measure a target SSB. By signaling to the network that the UE is configured to support the B-1-1 operation or the B-1-2 operation, the UE can reduce overall IE signaling needed to inform the network of the UE's capabilities to measure the SSB when it is not within the frequency range of the active BWP 820.

There may be four scenarios for RRM measurement, namely: scenario 1-intra-frequency measurement for UE supporting B-1-2 operation; scenario 2 inter-frequency measurement for UE supporting B-1-1 operation; scenario 3 inter-frequency measurement for UE supporting B-1-2 operation; and a final scenario for intra-frequency measurement for UE support of B-1-1 operation that is described in PCT application no. PCT/CN 2023/110332, filed Jul. 31, 2023, and entitled “Intra-Frequency RRM Measurement for UE Supporting BWP Without Restriction and Without Interruption”.

### Scenario 1: Intra-Frequency Measurement for UE Supporting B-1-2

In a first example, a dependency may be defined (e.g., in a standard, such as a 3GPP standard) between B-1-2 implementation the and NeedForGaps/NCSG IEs. As described above, the UE 106 may report UE capabilities to the network including whether the UE supports the B-1-2 capability, e.g., UE capability B-1-2.

In a first option of the defined dependency, if the UE 106 indicates support of the B-1-2 capability, then the network may assume that the UE 106 supports intra-frequency RRM measurement without gap, but with interruption, on the same band via an information element (IE), such as NeedForGaps or NCSG. This dependency between the UE capability B-1-2 and the NeedForGaps IE may be expressed, for example, in the 3GPP standards as follows: if UE indicates B-1-2, then the network can assume the UE would indicate ‘no-gap-with-interruption’ for parameter ‘interruptionIndication-r18’ in ‘intraFreq-needForInterruption-r18’ for serving cells on the same band (assuming support of B-1-2 is indicated per band). The UE would also indicate ‘no-gap’ for parameter ‘gapIndicationIntra-r16’ corresponding to the serving cell. If the UE indicates differently for parameter ‘interruptionIndication-r18’ in ‘intraFreq-needForInterruption-r18’, the corresponding indication will be overridden by B-1-2 and ignored. If UE indicates differently for parameter ‘gapIndicationIntra-r16’ for the corresponding serving cells in ‘NeedForGapsIntraFreq-r16’, the corresponding indication will be overridden by B-1-2 and ignored.

This dependency between the UE capability B-1-2 and the NCSG IE may be expressed, for example, in the 3GPP standards as follows: if UE indicates B-1-2, then the network can assume UE would indicate ‘ncsg’ for parameter ‘gapIndicationIntra-r17’ in ‘NeedForNCSG-IntraFreq-r17’ for serving cells on the same band (assuming support of B-1-2 is indicated per band). If the UE indicates differently for parameter ‘gapIndicationIntra-r17’ in ‘NeedForNCSG-IntraFreq-r17’, the corresponding indication will be overridden by B-1-2 and ignored.

Thus, in the first example of defining a dependency between B-1-2 implementation and the NeedForGaps/NCSG IEs, the first option defines the dependency from the standpoint of the UE capability B-1-2, and reduces the need for additional signaling by the UE.

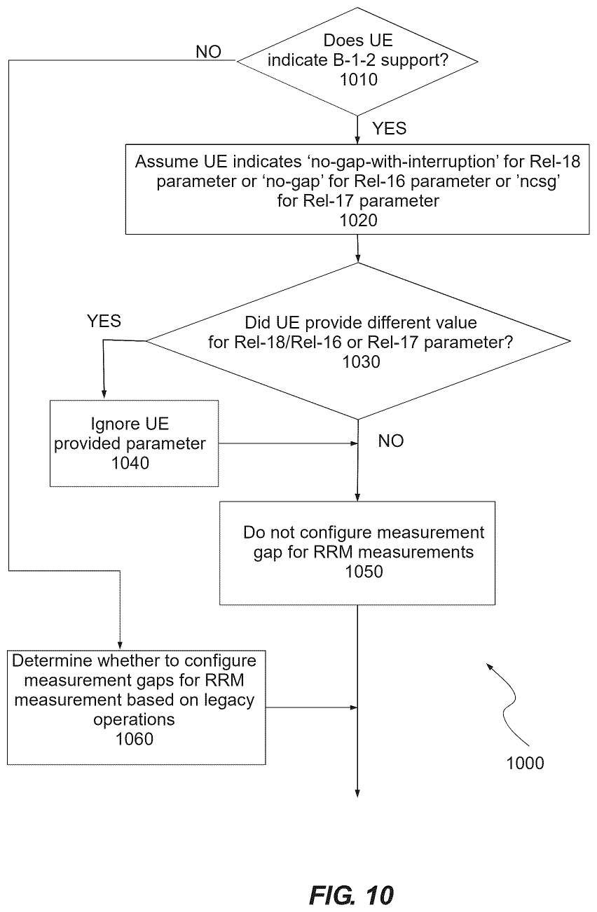

### FIG. 10: Flow Chart of a Method for Determining a Measurement Gap Configuration for RRM Measurements

FIG. 10 shows a first method 1000 for determining a measurement gap configuration for RRM measurements according to various example embodiments. It should be understood that the method 1000 describes the operation of the first option of the first example. The method 1000 is described from the standpoint of the network, e.g., the operations are performed by a network component such as a base station. In the example of FIG. 10, the network component performing the operations is the gNB 102 but this is only an example and other network components may perform the example operations.

In 1010, the gNB 102 determines whether the UE 106 has indicated that it supports B-1-2 operation. In one example, the UE 106 supports B-1-2 operation when the UE is capable of periodically or occasionally extending a monitored frequency range to include the frequency range of the active BWP 820 and the SSB 830 to enable the UE to perform no-gap with interruption measurements of the SSB for RRM or RLM/BM/BFD. As described above, in one example, the UE may indicate support for B-1-2 operation using a UE capability IE.

If the UE 106 does not support B-1-2 operations, the gNB 102 may determine whether to configure measurement gaps for various RRM measurements based on legacy operations in 1060.

If the UE 106 supports B-1-2 operations, the gNB 102 will assume that the UE also supports gapless RRM measurements for mobility. A first category of RRM measurements may be those measurements related to the B-1-2 operations, e.g., L1 measurements for RLM/BM/BFD. This category of measurements may be referred to as measurements for RLM/BM/BFD or B-1-2 related measurements. A second category of RRM measurements may be mobility related RRM measurements, e.g., handover, CA/DC management, etc. These measurements may be L1 or Layer 3 (L3) measurements. This category of measurements may be referred to as RRM mobility related measurements or intra-frequency or inter-frequency RRM measurements without gap or no-gap. Furthermore, these different categories may also be referred to as different types of RRM measurements, where the first category may be referred to as a first or second type of RRM measurement and the second category may be referred to as a first or second type of RRM measurement.

As described above, the gNB 102 will assume the UE 106 supports no-gap with-interruption RRM measurements for mobility based on assumed values of various parameters that may be used to signal a UE capability to support the gapless RRM measurements for mobility. As described above, these parameters may be included in a NeedForGaps or NCSG IE. In a first NeedForGaps example, in Rel-18 of the 3GPP standards the parameter may be the ‘interruptionIndication-r 18’ parameter in the ‘intraFreq-needForInterruption-r18’ IE having a value of ‘no-gap-with-interruption’. The gNB 102 will assume the UE 106 supports no-gap with-interruption RRM measurements for mobility for serving cells on the same band as support of B-1-2 is indicated.

In a second NeedForGaps example, in Rel-16 of the 3GPP standards the parameter may be the ‘gapIndicationIntra-r16’ parameter having a value of ‘no-gap’. In this case, the gNB 102 will assume the UE 106 supports no-gap with-interruption RRM measurements corresponding to the serving cell indicated by the parameter.

In an NCSG example, in Rel-17 the parameter may be the ‘gapIndicationIntra-r17’ parameter in the ‘NeedForNCSG-IntraFreq-r17’ IE having the value ‘ncsg.’ The gNB 102 will assume the UE 106 supports no-gap with-interruption RRM measurements for mobility for serving cells on the same band as support of B-1-2 is indicated. The above parameters and values are only used as examples and other parameters and/or values may be used for the purposes of gapless RRM measurements for mobility.

In 1020, the gNB 102 assumes or infers the values of the various parameters based on the receipt of the indication from the UE 106 that the UE 106 supports B-1-2 operation. However, the gNB 102 may receive actual values for the parameters indicating whether the UE 106 supports gapless RRM measurements for mobility, e.g., in a UE capability IE. As shown in 1030, the gNB 102 may determine that the actual received values for these parameter(s) are different from the assumed or inferred values. If the values are different, in 1040, the gNB 102 will ignore the actual values and continue to assume that the UE 106 supports no-gap with-interruption RRM measurements for mobility based on the receipt of the indication that the UE 106 supports B-1-2 operations.

In 1050, the gNB 102 may configure the UE 106 for RRM measurements for mobility. In this scenario, because the gNB 102 assumes that the UE 106 supports no-gap with-interruption RRM measurements for mobility, the configuration will not include any measurement gaps.

In a second example, a dynamic dependency may be introduced and applied to either of the first or second examples. For example, in a first option of the second example, a new indication (X1) from the UE 106 to the network (e.g., gNB 102) may be introduced regarding applicability of the dependencies disclosed by the first and/or second examples. The new indication (X1) may indicate any of the following: (a) a number of active serving cells, (b) a number of configured serving cells (including both active and deactivated cells) or (c) a number of bands with configured serving cells.

This new indication (X1) may be used by the network to determine if the dependencies described above for the first and/or second examples are applicable. For example, if the number of cells/bands do not exceed the value of (X1), then the dependencies of the first and/or second examples apply. If the number of cells/bands exceed the value of (X1), then the dependencies of the first and/or second examples do not apply. The new indication (X1) may be indicated per UE or per frequency range (FR).

In a second option of the second example, a new IE in an RRC reconfiguration complete message may be used to indicate whether the dependencies in the first and/or second examples are applicable. This option may be appropriate when there is a change of CA/DC configuration because this is accomplished via an RRC reconfiguration from the network to the UE 106. The UE 106 then sends an RRC reconfiguration complete message after each change. Accordingly, the new IE can be included in the RRC reconfiguration complete message.

In a third option of the second example, a predefined threshold (X1) may apply when the UE 106 indicates support of the B-1-2 capability regarding the applicability of the dependencies of the first and/or second examples. Similar to the first option, the predefined threshold (X1) may indicate any of the following: (a) a number of active serving cells, (b) a number of configured serving cells (including both active and deactivated cells) or (c) a number of bands with configured serving cells. Also similar to the first option, this predefined threshold (X1) may be used by the network to determine if the dependencies described above for the first and/or second examples are applicable. For example, if the number of cells/bands do not exceed the value of (X1), then the dependencies of the first and/or second examples apply. If the number of cells/bands exceed the value of (X1), then the dependencies of the first and/or second examples do not apply.

In some examples, the predefined threshold (X1) may be applied for the same capability type as the B-1-2 capability, e.g., if B-1-2 capability is per-UE then (X1) is per-UE, or if B-1-2 is per band then (X1) is per-band. In other examples, the predefined threshold (X1) may be applied per UE or per FR.

The second example provides a dynamic indication of whether the dependencies of the first and second examples are applicable. The above description of the first and second examples provided examples of performing RRM measurements when the dependencies of the first and second examples are applicable. However, if the dependencies do not apply, the network may check UE feedback regarding support of two features independently. For example, support of B-1-2 capability only means that the UE 106 can perform RLM/BM/BFD when a target SSB is outside of the active BWP (e.g. outside of the frequency range of the active BWP) but it does not mean that the UE 106 can support RRM measurements on the target SSB without a gap.

In one aspect, the gNB 102 can have one or more processors 204 configured to decode, from signaling received from the UE 106, an indication that the UE 106 is capable to periodically change an actual BW 940 of the UE 106 within a CBW 810 to include an active BWP 820 and a bandwidth of a target SSB 830 of the gNB 102 located in the CBW 810 and outside the active BWP 820 of the UE 106 (i.e. B-1-2 capability). The processors 204 can determine, based on at least the indication, that the UE 106 supports a no-gap measurement for an intra-frequency measurement of the target SSB. The processors 204 can encode, for transmission to the UE 106, one or more downlink signals to enable the UE 106 to perform measurements of the target SSB with no-gap. In another aspect, the processors 204 can encode the one or more downlink signals to enable the UE 106 to perform measurements of the target SSB with-interruption. The gNB 102 can also have a memory 260 coupled to the one or more processors 204.

In another aspect, the indication can further comprise that the UE 106 supports no-gap and with-interruption measurement of the target SSB. The processors 204 can be configured to encode, for transmission to the UE, the one or more downlink signals to enable the UE 106 to perform the one or more measurements from the measurement of the target SSB with no-gap and with-interruption.

In another aspect, the indication can further comprise that the UE 106 supports a no-gap-with-interruption measurement of the target SSB comprising one or more of Radio Link Monitoring (RLM) measurements, Beam Management (BM) measurements, or Beam Failure Detection (BFD) measurements. The processors 204 can be configured to encode, for transmission to the UE 106, the one or more downlink signals to enable the UE 106 to perform a no-gap-with-interruption measurement of the target SSB comprising Radio Resource Management (RRM) mobility measurements.

In another aspect, the indication can further comprise that the UE 106 supports a capability to periodically or occasionally change the actual BW 940 of the UE 106 within the CBW 810 to include the bandwidth of the target SSB 830 per frequency band (i.e. B-1-2 capability). In another aspect, the indication can further comprise that the UE 106 is capable of increasing the actual BW 940 of the UE 106 within the CBW 810 to include the active BWP 820 and the BW of the target SSB 830 to measure the RRM of the target SSB, and capable of decreasing the actual BW 940 of the UE 106 to include the active BWP 820 and exclude the BW of the target SSB 830 after measuring the RRM of the target SSB (i.e. B-1-2 capability).

In another aspect, the target SSB 830 can be located in the CBW 810 of the UE 106 and outside the active BWP 820 of the UE 106 in the CBW 810.

In another aspect, the intra-frequency measurement can comprise a center frequency of an SSB of a serving cell and a center frequency of an SSB of a neighbor cell are a same frequency and a same subcarrier spacing of the SSB of the serving cell and the SSB of the neighbor cell.

In another aspect, the indication can further comprise that the UE 106 supports intra-frequency radio resource management (RRM) measurement of the target SSB. In another aspect, the indication can further comprise that the UE 106 supports no-gap measurement for radio resource management (RRM) measurements of the target SSB.

In another aspect, the processors 204 cam be further configured to decode, from signaling received from the UE 106, an indication that the UE 106 supports a no-gap and with-interruption measurement for a first type of measurement of the SSB comprising Radio Link Monitoring (RLM) measurements, Beam Management (BM) measurements, or Beam Failure Detection (BFD) measurements. The processors 204 can determine, based on at least the indication, that the UE 106 supports no-gap and with-interruption measurement for a second type of measurement of the SSB comprising RRM mobility measurements. The processors 204 can encode, for transmission to the UE 106, with no-gap and with-interruption on a same frequency a configuration for the second type of measurement of the SSB comprising a no-gap and with-interruption measurement.

In another aspect, the processors 204 can determine the UE 106 supports a no-gap and with-interruption measurement of the target SSB based on the UE 106 supporting a ‘no-gap-with-interruption’ value for a ‘interruptionIndication-r18’ parameter in a ‘intraFreq-needForInterruption-r18’ information element (IE) for serving cells on a same band as indicated by the UE being capable to periodically change the actual BW of the UE within the CBW to include the bandwidth of the target SSB (i.e. B-1-2 capability). In another aspect, the processors 204 can be further configured to decode, from signaling received from the UE 106, UE capability information comprising a value for the ‘interruptionIndication-r18’ parameter in the ‘intraFreq-needForInterruption-r18’ information element (IE), wherein the value is different from the ‘no-gap-with-interruption’ value. The processors 204 can ignore the value of the ‘interruptionIndication-r18’ parameter when the processors 204 determine that the UE 106 supports a no-gap and with-interruption measurement of the target SSB.

In another aspect, the processors 204 can determine the UE 106 supports no-gap and with-interruption measurement of the RRM measurement of the target SSB based on the UE supporting a ‘no-gap’ value for a ‘gapIndicationIntra-r16’ parameter corresponding to a serving cell as indicated by the UE being capable to periodically change the actual BW of the UE within the CBW to include the bandwidth of the target SSB (i.e. B-1-2 capability). In another aspect, the processors 204 can be further configured to decode, from signaling received from the UE 106, UE capability information comprising a value for the ‘gapIndicationIntra-r16’ parameter, wherein the value is different from the ‘no-gap’ value. The processors 204 can ignore the value of the ‘gapIndicationIntra-r16’ parameter when the one or more processors determines the UE supports a no-gap and with-interruption measurement of the RRM measurement of the target SSB.

In another aspect, the processors 204 can determine the UE 106 supports a no-gap and with-interruption measurement of the target SSB based on the UE supporting a ‘ncsg’ value for a ‘gapIndicationIntra-r17’ parameter in a ‘NeedForNCSG-IntraFreq-r17’ information element (IE) for serving cells on a same band as indicated by the UE being capable to periodically change the actual BW of the UE within the CBW to include the bandwidth of the target SSB (i.e. B-1-2 capability). In another aspect, the processors 204 can be further configured to decode, from signaling received from the UE 106, UE capability information comprising a value for the ‘gapIndicationIntra-r17’ parameter in the ‘NeedForNCSG-IntraFreq-r17’ IE, wherein the value is different from the ‘ncsg’ value. The processors 204 can ignore the value of the ‘gapIndicationIntra-r17’ parameter when the processors 204 determine the UE 106 supports no-gap and with-interruption measurement of the target SSB.

In another aspect, the processors 204 can be further configured to decode, from signaling received from the UE 106, a dynamic dependency indication parameter comprising a value, wherein the processors 204 determine the UE 106 supports a no-gap and with-interruption measurement for the SSB further based on whether the UE is configured with one of (i) a number of active serving cells, (ii) a number of configured serving cells comprising active and deactivated serving cells, or (iii) a number of bands with configured serving cells, that do not exceed the value of the dynamic dependency indication parameter. In another aspect, the value of the dynamic dependency indication parameter can be indicated per UE or per frequency range (FR).

In another aspect, the processors 204 can be further configured to decode, from signaling received from the UE 106, an information element (IE) in a Radio Resource Control (RRC) reconfiguration complete message comprising an indication related to the UE supporting being capable to periodically change the actual BW of the UE within the CBW to include the bandwidth of the target SSB (i.e. B-1-2 capability). The processors 204 can determine the UE 106 supports a no-gap and with-interruption measurement for the target SSB further based on the indication.

In another aspect, the gNB 102 can be preconfigured with a parameter comprising a value. The processors 204 can determine the UE 106 supports a no-gap and with-interruption measurement for the target SSB further based on whether the UE is configured with one of (i) a number of active serving cells, (ii) a number of configured serving cells comprising active and deactivated serving cells, or (iii) a number of bands with configured serving cells, that do not exceed the value of the parameter. In one aspect, the value of the parameter is indicated per UE or per frequency range (FR).

### Scenario 2: Inter-Frequency Measurement for UE Supporting B-1-1

In a first example, if UE 106 supports inter-frequency RRM measurement without gap or interruption in the target band via NeedForGaps or NCSG, then the network can assume the UE 102 supports option B-1-1 on the same band. This dependency between the UE capability B-1-1 and the NeedForGaps IE may be expressed, for example, in the 3GPP standards as follows: if UE indicates ‘no-gap-no-interruption’ for parameter ‘interruptionIndication-r18’ ‘interFreq-needForInterruption-r18’ for target band, then network can assume UE supports B-1-1 on the same band (assuming support of B-1-1 is indicated per band).

This dependency between the UE capability B-1-1 and the NCSG IE may be expressed, for example, in the 3GPP standards as follows: if UE indicates ‘nogap-noncsg’ for parameter ‘gapIndicationIntra-r17’ in ‘NeedForNCSG-IntraFreq-r17’ for target band, then NW can assume UE supports B-1-1 on the same band (assuming support of B-1-1 is indicated per band).

Thus, in the first example of defining a dependency between B-1-1 implementation and the NeedForGaps/NCSG IEs, the first option defines the dependency from the standpoint of the NeedForGaps/NCSG IEs.

In a second example, a dependency may be defined (e.g., in the 3GPP standards) between B-1-1 and inter-frequency RRM measurement without gap based on UE capability ‘interFrequencyMeas-NoGap-r16’. This dependency between the UE capability B-1-1 and the inter-frequency RRM measurement without gap may be expressed, for example, in the 3GPP standards as follows: if UE indicates B-1-1, then the network can assume UE would indicate support of ‘interFrequencyMeas-NoGap-r16’.

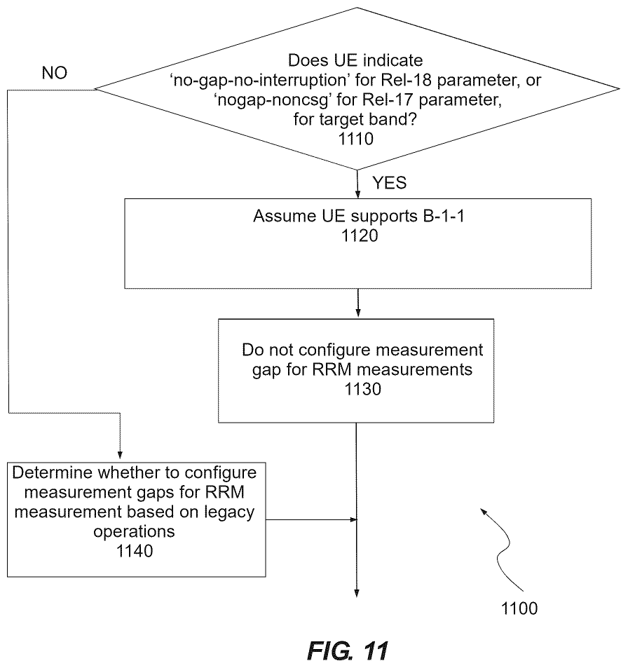

### FIG. 11: Flow Chart of a Method for Determining a Measurement Gap Configuration for RRM Measurements

FIG. 11 shows a second method 1100 for determining a measurement gap configuration for RRM measurements according to various example embodiments. It should be understood that the method 1100 describes the operation of the first option of the first example. The method 1100 is described from the standpoint of the network, e.g., the operations are performed by a network component such as a base station. In the example of FIG. 11, the network component performing the operations is the gNB 102 but this is only an example and other network components may perform the example operations.

In 1110, the gNB 102 determines whether the UE 106 has indicated that it supports inter-frequency RRM measurements without gap or interruption. The UE 106 may provide this indication via a parameter in a UE capability IE or other type of IE. For example, the indication may be a ‘no-gap-no-interruption’ value for the ‘interruptionIndication-r18’ parameter in the ‘interFreq-needForInterruption-r18’ IE. In another example, the indication may be a ‘nogap-noncsg’ value for the ‘gapIndicationIntra-r17’ parameter in the ‘NeedForNCSG-IntraFreq-r17’ IE. These parameters and values are only used as examples and other parameters and/or values may be used for the purposes of indicating support for intra-frequency RRM measurements without gap.

If the UE 106 does not support inter-frequency RRM measurements without gap or interruption, the gNB 102 may determine whether to configure measurement gaps for various RRM measurements based on legacy operations in 1140.

In 1120, when the UE 106 supports inter-frequency RRM measurements without gap or interruption, the gNB 102 assumes that the UE 106 also supports B-1-1 operation on the same band as the UE supports inter-frequency RRM measurements without gap or interruption, e.g., the UE 106 is capable of extending a monitored frequency range to include the frequency range of the active BWP 820 and the SSB 830 to perform gapless measurements for RRM or RLM/BM/BFD.

Thus, in 1130, the gNB 102 may configure the UE 106 for RRM measurements or RLM/BM/BFD measurements. In this scenario, because the gNB 102 assumes that the UE 106 supports B-1-1 operation, the configuration will not include any measurement gaps.

In a third example, a dynamic dependency may be introduced and applied to either of the first or second examples. For example, in a first option of the second example, a new indication (X2) from the UE 106 to the network (e.g., gNB 102) may be introduced regarding applicability of the dependencies disclosed by the first and/or second examples. The new indication (X2) may indicate any of the following: (a) a number of active serving cells, (b) a number of configured serving cells (including both active and deactivated cells) or (c) a number of bands with configured serving cells.

This new indication (X2) may be used by the network to determine if the dependencies described above for the first and/or second examples are applicable. For example, if the number of cells/bands do not exceed the value of (X2), then the dependencies of the first and/or second examples apply. If the number of cells/bands exceed the value of (X2), then the dependencies of the first and/or second examples do not apply. The new indication (X2) may be indicated per UE or per frequency range (FR).

In a second option of the second example, a new IE in an RRC reconfiguration complete message may be used to indicate whether the dependencies in the first and/or second examples are applicable. This option may be appropriate when there is a change of CA/DC configuration because this is accomplished via an RRC reconfiguration from the network to the UE 106. The UE 106 then sends an RRC reconfiguration complete message after each change. The new IE can be included in the RRC reconfiguration complete message.

In a third option of the second example, a predefined threshold (X2) may apply when the UE 106 indicates support of the B-1-1 capability regarding the applicability of the dependencies of the first and/or second examples. Similar to the first option, the predefined threshold (X2) may indicate any of the following: (a) a number of active serving cells, (b) a number of configured serving cells (including both active and deactivated cells) or (c) a number of bands with configured serving cells. Also similar to the first option, this predefined threshold (X2) may be used by the network to determine if the dependencies described above for the first and/or second examples are applicable. For example, if the number of cells/bands do not exceed the value of (X2), then the dependencies of the first and/or second examples apply. If the number of cells/bands exceed the value of (X2), then the dependencies of the first and/or second examples do not apply.

In some examples, the predefined threshold (X2) may be applied for the same capability type as the B-1-1 capability, e.g., if B-1-1 capability is per-UE then (X2) is per-UE, or if B-1-1 is per band then (X2) is per-band. In other examples, the predefined threshold (X2) may be applied per UE or per FR.

The second example provides a dynamic indication of whether the dependencies of the first and second examples are applicable. The above description of the first and second examples provided examples of performing RRM measurements when the dependencies of the first and second examples are applicable. However, if the dependencies do not apply, the network may check UE feedback regarding support of two features independently. For example, support of B-1-1 capability only means the UE 106 can perform RLM/BM/BFD when target SSB is outside active BWP but it does not mean the UE 106 can support RRM measurements on target SSB without gap.

In one aspect, the base station or gNB 102 can have one or more processors 204 configured to decode, from signaling received from a UE 106, an indication that the UE supports inter-frequency no-gap and no-interruption measurement for measurement of a target SSB of the gNB 102. The processors 204 can determine, based on at least the indication, that the UE 106 supports changing an actual BW 840 of the UE 106 to match a CBW 810 that includes an active BWP 820 and a bandwidth of the target SSB 830 located in the CBW 810 and outside the active BWP 840 of the UE 106 (i.e. B-1-1 capability). The processors 204 can encode, for transmission to the UE 106, one or more downlink signals to enable the UE 106 to perform measurements of the target SSB with no-gap and no-interruption. The gNB 102 can have a memory 260 coupled to the one or more processors 204.

In another aspect, the indication can further comprise that the UE 106 supports no-gap and no-interruption measurement per frequency band.

In another aspect, the target SSB 830 can located in the CBW 810 of the UE 106 and outside the active BWP 820 of the UE 106 in the CBW 810.

In another aspect, the inter-frequency measurement can comprise a center frequency of an SSB of a serving cell and a center frequency of an SSB of a neighbor cell are a different frequency or a different subcarrier spacing of the SSB of the serving cell and the SSB of the neighbor cell.

In another aspect, the indication can further comprise that the UE 106 supports inter-frequency radio resource management (RRM) measurements of the target SSB.

In another aspect, the indication can further comprise a ‘no-gap-no-interruption’ value for a ‘interruptionIndication-r18’ parameter in a ‘interFreq-needForInterruption-r18’ information element (IE) for a target band.

In another aspect, the indication can further comprise a ‘nogap-noncsg’ value for a ‘gapIndicationIntra-r17’ parameter in a ‘NeedForNCSG-IntraFreq-r17’ information element (IE) for a target band.

In another aspect, the indication can further comprise the UE 106 supports changing the actual BW 840 of the UE 106 to match the CBW 810 that includes the active BWP 820 and the bandwidth of the target SSB 830 located in the CBW 810 and outside the active BWP 820 of the UE 106 (i.e. B-1-1-capability). The processors 204 can be configured to determine that the UE supports ‘interFrequencyMeas-NoGap-r16’.

In another aspect, the processors 204 can be further configured to decode, from signaling received from the UE 106, a dynamic dependency indication parameter comprising a value, wherein the processors 204 determine the UE supports a no-gap and with-interruption measurement for the SSB further based on whether the UE is configured with one of (i) a number of active serving cells, (ii) a number of configured serving cells comprising active and deactivated serving cells, or (iii) a number of bands with configured serving cells, that do not exceed the value of the dynamic dependency indication parameter. In another aspect, the value of the dynamic dependency indication parameter can be indicated per UE or per frequency range (FR).

In another aspect, the processors 204 can be further configured to decode, from signaling received from the UE 106, an information element (IE) in a Radio Resource Control (RRC) reconfiguration complete message comprising an indication related to the UE supporting being capable to periodically change the actual BW of the UE within the CBW to include the bandwidth of the target SSB (i.e. B-1-1-capability). The processors 204 can determine the UE supports a no-gap and with-interruption measurement for the target SSB further based on the indication.

In another aspect, the gNB 102 can be preconfigured with a parameter comprising a value. The processors 204 can determine the UE supports a no-gap and with-interruption measurement for the target SSB further based on whether the UE is configured with one of (i) a number of active serving cells, (ii) a number of configured serving cells comprising active and deactivated serving cells, or (iii) a number of bands with configured serving cells, that do not exceed the value of the parameter. In one aspect, the value of the parameter is indicated per UE or per frequency range (FR).

### Scenario 3: Inter-Frequency Measurement for UE Supporting B-1-2

In a first example, a dependency may be defined (e.g., in the 3GPP standards) between B-1-2 implementation and NeedForGaps/NCSG. As described above, the UE 106 may report UE capabilities to the network including whether the UE supports the B-1-2 capability, e.g., UE capability B-1-2.

In a first option of the defined dependency, if the UE 106 indicates support of the B-1-2 capability, then the network may assume the UE 106 supports inter-frequency RRM measurement without gap but with interruption on the same band via NeedForGaps or NCSG. This dependency between the UE capability B-1-2 and the NeedForGaps IE may be expressed, for example, in the 3GPP standards as follows: if UE indicates B-1-2, then network can assume the UE would indicate ‘no-gap-with-interruption’ for parameter ‘interruptionIndication-r18’ in ‘interFreq-needForInterruption-r18’ for inter-frequency measurement on the same band (assuming support of B-1-2 is indicated per band). The UE would indicate ‘no-gap’ for parameter ‘gapIndication-r16’ for inter-frequency measurement on the same band. If the UE indicates differently for parameter ‘interruptionIndication-r18’ in ‘interFreq-needForInterruption-r18’, the corresponding indication will be overridden by B-1-2 and ignored. If UE indicates differently for parameter ‘gapIndication-r16’ for inter-frequency measurement on the same band, the corresponding indication will be overridden by B-1-2 and ignored.

This dependency between the UE capability B-1-2 and the NCSG IE may be expressed, for example, in the 3GPP standards as follows: if UE indicates B-1-2, then the network can assume UE would indicate ‘ncsg’ for parameter ‘gapIndication-r17’ in ‘inter-Freq-NeedForNCSG-r17’ for inter-frequency measurement on the same band (assuming support of B-1-2 is indicated per band). If the UE indicates differently for parameter ‘gapIndication-r17’ in ‘inter-Freq-NeedForNCSG-r17’, the corresponding indication will be overridden by B-1-2 and ignored.

Thus, in the first example of defining a dependency between B-1-2 implementation and the NeedForGaps/NCSG IEs, the first option defines the dependency from the standpoint of the UE capability B-1-2.

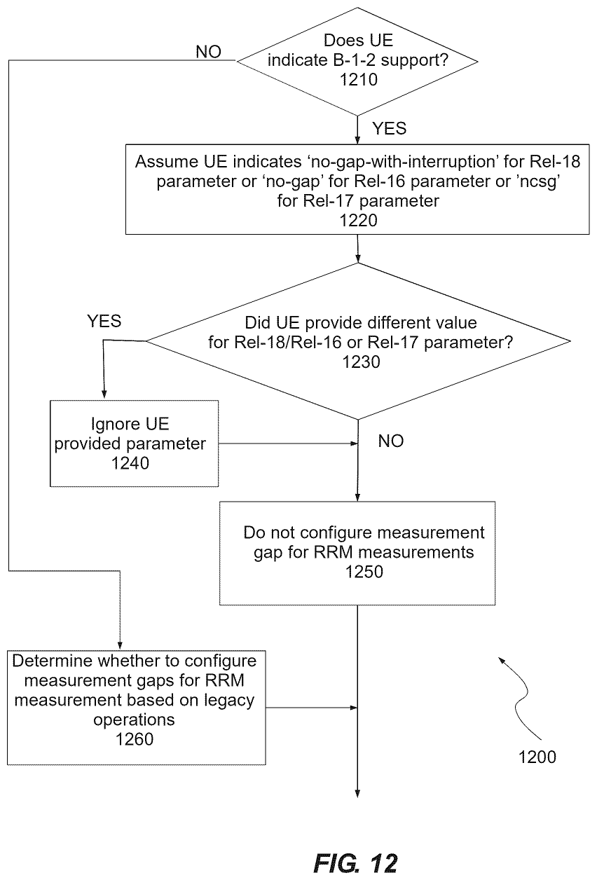

### FIG. 12: Flow Chart of a Method for Determining a Measurement Gap Configuration for RRM Measurements

FIG. 12 shows a first method 1200 for determining a measurement gap configuration for RRM measurements according to various example embodiments. It should be understood that the method 1200 describes the operation of the first option of the first example. The method 1200 is described from the standpoint of the network, e.g., the operations are performed by a network component such as a base station. In the example of FIG. 12, the network component performing the operations is the gNB 102 but this is only an example and other network components may perform the example operations.

In 1210, the gNB 102 determines whether the UE 106 has indicated that it supports B-1-2 operation, e.g., the UE 106 is capable of periodically or occasionally extending a monitored frequency range to include the frequency range of the active BWP 820 and the SSB 830 to perform no-gap with interruption measurements for RRM or RLM/BM/BFD. As described above, in one example, the UE may indicate support for B-1-2 operation using a UE capability IE.

If the UE 106 does not support B-1-2 operations, the gNB 102 may determine whether to configure measurement gaps for various RRM measurements based on legacy operations in 1260.

If the UE 106 supports B-1-2 operations, the gNB 102 will assume that the UE also supports gapless RRM measurements for mobility. Again, a first category of RRM measurements may be those measurements related to the B-1-2 operations, e.g., L1 measurements for RLM/BM/BFD. This category of measurements may be referred to as measurements for RLM/BM/BFD or B-1-2 related measurements. A second category of RRM measurements may be mobility related RRM measurements, e.g., handover, CA/DC management, etc. These measurements may be L1 or Layer 3 (L3) measurements. This category of measurements may be referred to as RRM mobility related measurements or intra-frequency or inter-frequency RRM measurements without gap or no-gap. Furthermore, these different categories may also be referred to as different types of RRM measurements, where the first category may be referred to as a first or second type of RRM measurement and the second category may be referred to as a first or second type of RRM measurement.

As described above, the gNB 102 will assume the UE 106 supports no-gap with-interruption RRM measurements for mobility based on assumed values of various parameters that may be used to signal a UE capability to support the gapless RRM measurements for mobility. As described above, these parameters may be included in a NeedForGaps or NCSG IE. In a first NeedForGaps example, in Rel-18 the parameter may be the ‘interruptionIndication-r18’ parameter in the ‘interFreq-needForInterruption-r18’ IE having a value of ‘no-gap-with-interruption’. The gNB 102 will assume the UE 106 supports no-gap with-interruption RRM measurements for mobility for serving cells on the same band as support of B-1-2 is indicated.

In a second NeedForGaps example, in Rel-16 the parameter may be the ‘gapIndicationIntra-r16’ parameter having a value of ‘no-gap’. In this case, the gNB 102 will assume the UE 106 supports no-gap with-interruption RRM measurements corresponding to the serving cell indicated by the parameter.

In an NCSG example, in Rel-17 the parameter may be the ‘gapIndication-r17’ parameter in the ‘inter-Freq-NeedForNCSG-r17’ IE having the value ‘ncsg.’ The gNB 102 will assume the UE 106 supports no-gap with-interruption RRM measurements for mobility for serving cells on the same band as support of B-1-2 is indicated. The above parameters and values are only used as examples and other parameters and/or values may be used for the purposes of gapless RRM measurements for mobility.

In 1220, the gNB 102 assumes or infers the values of the various parameters based on the receipt of the indication that the UE 106 supports B-1-2 operation. However, the gNB 102 may receive actual values for the parameters indicating whether the UE 106 supports gapless RRM measurements for mobility, e.g., in UE capability information. As shown in 1230, the gNB 102 may determine that the actual received values for these parameter(s) are different from the assumed or inferred values. If the values are different, in 1240, the gNB 102 will ignore the actual values and continue to assume that the UE 106 supports no-gap with-interruption RRM measurements for mobility based on the receipt of the indication that the UE 106 supports B-1-2 operations.

In 1250, the gNB 102 may configure the UE 106 for RRM measurements for mobility. In this scenario, because the gNB 102 assumes that the UE 106 supports no-gap with-interruption RRM measurements for mobility, the configuration will not include any measurement gaps.

In a second example, a dynamic dependency may be introduced and applied to either of the first or second examples. For example, in a first option of the second example, a new indication (X3) from the UE 106 to the network (e.g., gNB 102) may be introduced regarding applicability of the dependencies disclosed by the first and/or second examples. The new indication (X3) may indicate any of the following: (a) a number of active serving cells, (b) a number of configured serving cells (including both active and deactivated cells) or (c) a number of bands with configured serving cells.

This new indication (X3) may be used by the network to determine if the dependencies described above for the first and/or second examples are applicable. For example, if the number of cells/bands do not exceed the value of (X3), then the dependencies of the first and/or second examples apply. If the number of cells/bands exceed the value of (X3), then the dependencies of the first and/or second examples do not apply. The new indication (X3) may be indicated per UE or per frequency range (FR).

In a second option of the second example, a new IE in an RRC reconfiguration complete message may be used to indicate whether the dependencies in the first and/or second examples are applicable. This option may be appropriate when there is a change of CA/DC configuration because this is accomplished via an RRC reconfiguration from the network to the UE 106. The UE 106 then sends an RRC reconfiguration complete message after each change.

In a third option of the second example, a predefined threshold (X3) may apply when the UE 106 indicates support of the B-1-2 capability regarding the applicability of the dependencies of the first and/or second examples. Similar to the first option, the predefined threshold (X3) may indicate any of the following: (a) a number of active serving cells, (b) a number of configured serving cells (including both active and deactivated cells) or (c) a number of bands with configured serving cells. Also similar to the first option, this predefined threshold (X3) may be used by the network to determine if the dependencies described above for the first and/or second examples are applicable. For example, if the number of cells/bands do not exceed the value of (X3), then the dependencies of the first and/or second examples apply. If the number of cells/bands exceed the value of (X3), then the dependencies of the first and/or second examples do not apply.

In some examples, the predefined threshold (X3) may be applied for the same capability type as the B-1-2 capability, e.g., if B-1-2 capability is per-UE then (X3) is per-UE, or if B-1-2 is per band then (X3) is per-band. In other examples, the predefined threshold (X3) may be applied per UE or per FR.

The second example provides a dynamic indication of whether the dependencies of the first and second examples are applicable. The above description of the first and second examples provided examples of performing RRM measurements when the dependencies of the first and second examples are applicable. However, if the dependencies do not apply, the network may check UE feedback regarding support of two features independently. For example, support of B-1-2 capability only means the UE 106 can perform RLM/BM/BFD when target SSB is outside the active BWP but it does not mean the UE 106 can support RRM measurements on target SSB without gap.

In one aspect, a base station or gNB 102 can have one or more processors 204 configured to decode, from signaling received from a UE 106, an indication that the UE 106 is capable to periodically change an actual BW 940 of the UE 106 within a CBW 810 to include an active BWP 820 and a bandwidth of a target SSB 830 of the gNB 102 located in the CBW 810 and outside the active BWP 820 of the UE 106 (i.e. B-1-2 capability). The processors 204 can determine, based on at least the indication, that the UE supports a no-gap measurement for an inter-frequency measurement of the target SSB. The processors 204 can encode, for transmission to the UE 106, one or more downlink signals to enable the UE 106 to perform measurements of the target SSB with no-gap. The gNB 102 can have a memory 240 coupled to the one or more processors 204.

In another aspect, the indication can further comprise that the UE 106 supports no-gap and with-interruption measurement of the target SSB. The processors 204 can be configured to encode, for transmission to the UE, the one or more downlink signals to enable the UE to perform the one or more measurements from the measurement of the target SSB with no-gap and with-interruption.

In another aspect, the indication can further comprise that the UE supports a no-gap and with-interruption measurement of the target SSB comprising one or more Radio Link Monitoring (RLM) measurements, Beam Management (BM) measurements, or Beam Failure Detection (BFD) measurements. The processors 204 can be configured to encode, for transmission to the UE 106, the one or more downlink signals to enable the UE to perform a no-gap with-interruption measurement of the target SSB comprising Radio Resource Management (RRM) mobility measurements.

In another aspect, the indication can further comprise that the UE 106 supports a capability to periodically change the actual BW 940 of the UE 106 within the CBW 810 to include the bandwidth of the target SSB 830 per frequency band (i.e. B-1-2 capability). In another aspect, the indication can further comprise that the UE 106 is capable of increasing the actual BW 940 of the UE 106 within the CBW 810 to include the active BWP 820 and the BW of the target SSB 830 to measure the target SSB 830, and capable of decreasing the actual BW 940 of the UE 106 to include the active BWP 820 and exclude the BW of the target SSB 830 after measuring the target SSB 830 (i.e. B-1-2 capability). In another aspect, the target SSB 830 can be located in the CBW 810 of the UE 106 and outside the active BWP 820 of the UE 106 in the CBW 810.

In another aspect, the inter-frequency measurement can comprise a center frequency of an SSB of a serving cell and a center frequency of an SSB of a neighbor cell are a different frequency or a different subcarrier spacing of the SSB of the serving cell and the SSB of the neighbor cell.

In another aspect, the indication can further comprise that the UE 106 supports inter-frequency radio resource management (RRM) measurement of the target SSB.

In another aspect, the indication can further comprise that the UE 106 supports no-gap measurement for radio resource management (RRM) measurements of the target SSB.

In another aspect, the processors 204 can be further configured to decode, from signaling received from a UE 106, an indication that the UE 106 supports a no-gap and with-interruption measurement for a first type of measurement of the SSB comprising Radio Link Monitoring (RLM) measurements, Beam Management (BM) measurements, or Beam Failure Detection (BFD) measurements. The processors 204 can determine, based on at least the indication, that the UE 106 supports no-gap and with-interruption measurement for a second type of measurement of the SSB comprising Radio Resource Management (RRM) mobility measurements. The processors 204 can encode, for transmission to the UE 106, with no-gap and with-interruption on a same frequency a configuration for the second type of measurement of the SSB comprising a no-gap and with-interruption measurement.

In another aspect, the processors 204 can determine the UE 106 supports no-gap and with-interruption measurement of the target SSB based on the UE supporting a ‘no-gap-with-interruption’ value for a ‘interruptionIndication-r18’ parameter in a ‘interFreq-needForInterruption-r18’ information element (IE) for inter-frequency measurement on a same band as indicated by the UE being capable to periodically change the actual BW of the UE within the CBW to include the bandwidth of the target SSB (e.g. B-1-2 capability). In another aspect, the processors 204 can be further configured to decode, from signaling received from the UE 106, UE capability information comprising a value for the ‘interruptionIndication-r18’ parameter in the ‘interFreq-needForInterruption-r18’ information element (IE), wherein the value is different from the ‘no-gap-with-interruption’ value. The processors 204 can ignore the value of the ‘interruptionIndication-r18’ parameter when the processors 204 determine that the UE 106 supports a no-gap and with-interruption measurement the target SSB.

In another aspect, the processors 204 can determine the UE 106 supports no-gap and with-interruption measurement of the RRM measurement of the target SSB based on the UE supporting a ‘no-gap’ value for a ‘gapIndicationIntra-r16’ parameter for inter-frequency measurement on the same band as indicated by the UE being capable to periodically change the actual BW of the UE within the CBW to include the bandwidth of the target SSB (I.E. B-1-2 capability). In another aspect, the processors 204 can be further configured to: decode, from signaling received from the UE 106, UE capability information comprising a value for the ‘gapIndicationIntra-r16’ parameter, wherein the value is different from the ‘no-gap’ value. The processors 204 can ignore the value of the ‘gapIndicationIntra-r16’ parameter when the processors 204 determine the UE 106 supports a no-gap and with-interruption measurement of the RRM measurement of the target SSB.

In another aspect, the processors 204 can determine the UE 106 supports a no-gap and with-interruption measurement of the target SSB based on the UE supporting a ‘ncsg’ value for a ‘gapIndicationIntra-r17’ parameter in a ‘NeedForNCSG-IntraFreq-r17’ information element (IE) for inter-frequency measurement on a same band as indicated by the UE being capable to periodically change the actual BW of the UE within the CBW to include the bandwidth of the target SSB. In another aspect, the processors 204 can be further configured to decode, from signaling received from the UE 106, UE capability information comprising a value for the ‘gapIndicationIntra-r17’ parameter in the ‘NeedForNCSG-IntraFreq-r17’ IE, wherein the value is different from the ‘ncsg’ value. The processors 204 can ignore the value of the ‘gapIndicationIntra-r17’ parameter when the processors 204 determine the UE 106 supports no-gap and with-interruption measurement of the target SSB.

In another aspect, the processors 204 can be further configured to decode, from signaling received from the UE 106, a dynamic dependency parameter comprising a value, wherein the one or more processors determines the UE supports a no-gap and with-interruption measurement for the SSB further based on whether the UE is configured with one of (i) a number of active serving cells, (ii) a number of configured serving cells comprising active and deactivated serving cells, or (iii) a number of bands with configured serving cells, that do not exceed the value of the dynamic dependency indication parameter. In another aspect, the value of the dynamic dependency parameter is indicated per UE or per frequency range (FR).

In another aspect, the processors 204 can be further configured to decode, from signaling received from the UE 106, an information element (IE) in a Radio Resource Control (RRC) reconfiguration complete message comprising an indication related to the UE supporting being capable to periodically change the actual BW of the UE within the CBW to include the bandwidth of the target SSB. The processors 204 can determine the UE 106 supports a no-gap and with-interruption measurement for the target SSB further based on the indication.

In another aspect, the gNB 102 can be preconfigured with a parameter comprising a value. The processors 204 can determine the UE 106 supports a no-gap and with-interruption measurement for the target SSB further based on whether the UE is configured with one of (i) a number of active serving cells, (ii) a number of configured serving cells comprising active and deactivated serving cells, or (iii) a number of bands with configured serving cells, that do not exceed the value of the parameter. In another aspect, the value of the parameter is indicated per UE or per frequency range (FR).

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus of a next generation node B (gNB), the apparatus comprising:
one or more processors configured to:
decode, from signaling received from a user equipment (UE), an indication that the UE is capable to periodically change an actual bandwidth (BW) of the UE within a channel bandwidth (CBW) to include an active bandwidth part (BWP) and a bandwidth of a target Synchronization Signal Block (SSB) of the gNB located in the CBW and outside the active BWP of the UE;
determine, based on at least the indication, that the UE supports a no-gap measurement for an intra-frequency measurement of the target SSB; and
encode, for transmission to the UE, one or more downlink signals to enable the UE to perform measurements of the target SSB with no-gap; and
a memory coupled to the one or more processors.

2. The apparatus of claim 1, wherein the indication further comprises that the UE supports no-gap and with-interruption measurement of the target SSB; and wherein the one or more processors is configured to encode, for transmission to the UE, the one or more downlink signals to enable the UE to perform the one or more measurements from the measurement of the target SSB with no-gap and with-interruption.

3. The apparatus of claim 1, wherein the indication further comprises that the UE supports a no-gap-with-interruption measurement of the target SSB comprising one or more of Radio Link Monitoring (RLM) measurements, Beam Management (BM) measurements, or Beam Failure Detection (BFD) measurements; and wherein the one or more processors is configured to encode, for transmission to the UE, the one or more downlink signals to enable the UE to perform a no-gap-with-interruption measurement of the target SSB comprising Radio Resource Management (RRM) mobility measurements.

4. The apparatus of claim 1, wherein the indication further comprises that the UE supports a capability to periodically change the actual BW of the UE within the CBW to include the bandwidth of the target SSB per frequency band.

5. The apparatus of claim 1, wherein the target SSB is located in the CBW of the UE and outside the active BWP of the UE in the CBW.

6. The apparatus of claim 1, wherein the intra-frequency measurement comprises a center frequency of an SSB of a serving cell and a center frequency of an SSB of a neighbor cell are a same frequency and a same subcarrier spacing of the SSB of the serving cell and the SSB of the neighbor cell.

7. The apparatus of claim 1, wherein the indication further comprises that the UE supports intra-frequency radio resource management (RRM) measurement of the target SSB.

8. The apparatus of claim 1, wherein the indication further comprises that the UE supports no-gap measurement for radio resource management (RRM) measurements of the target SSB.

9. The apparatus of claim 1, wherein the indication further comprises that the UE is capable of increasing the actual BW of the UE within the CBW to include the active BWP and the BW of the target SSB to perform radio resource management (RRM) measurements of the target SSB, and capable of decreasing the actual BW of the UE to include the active BWP and exclude the BW of the target SSB after measuring the RRM of the target SSB.

10. The apparatus of claim 1, wherein the one or more processors is further configured to:
decode, from signaling received from the UE, an indication that the UE supports a no-gap and with-interruption measurement for a first type of measurement of the SSB comprising Radio Link Monitoring (RLM) measurements, Beam Management (BM) measurements, or Beam Failure Detection (BFD) measurements;
determine, based on at least the indication, that the UE supports no-gap and with-interruption measurement for a second type of measurement of the SSB comprising Radio Resource Management (RRM) mobility measurements; and
encode, for transmission to the UE, with no-gap and with-interruption on a same frequency a configuration for the second type of measurement of the SSB comprising a no-gap and with-interruption measurement.

11. The apparatus of claim 1, wherein the one or more processors is further configured to determine the UE supports a no-gap and with-interruption measurement of the target SSB based on the UE supporting a ‘no-gap-with-interruption’ value for a ‘interruptionIndication-r18’ parameter in a ‘intraFreq-needForInterruption-r18’ information element (IE) for serving cells on a same band as indicated by the UE being capable to periodically change the actual BW of the UE within the CBW to include the bandwidth of the target SSB.

12. The apparatus of claim 11, wherein the one or more processors is further configured to:
decode, from signaling received from the UE, UE capability information comprising a value for the ‘interruptionIndication-r18’ parameter in the ‘intraFreq-needForInterruption-r18’ information element (IE), wherein the value is different from the ‘no-gap-with-interruption’ value; and
ignore the value of the ‘interruptionIndication-r18’ parameter when the one or more processors is further configured to determine that the UE supports a no-gap and with-interruption measurement of the target SSB.

13. The apparatus of claim 1, wherein the one or more processors is further configured to determine that the UE supports no-gap and with-interruption measurement of the target SSB based on the UE supporting a ‘no-gap’ value for a ‘gapIndicationIntra-r16’ parameter corresponding to a serving cell as indicated by the UE being capable to periodically change the actual BW of the UE within the CBW to include the bandwidth of the target SSB.

14. The apparatus of claim 13, wherein the one or more processors is further configured to:
decode, from signaling received from the UE, UE capability information comprising a value for the ‘gapIndicationIntra-r16’ parameter, wherein the value is different from the ‘no-gap’ value; and
ignore the value of the ‘gapIndicationIntra-r16’ parameter when the one or more processors is further configured to determine that the UE supports a no-gap and with-interruption measurement of the target SSB.

15. The apparatus of claim 1, wherein the one or more processors is further configured to determine that the UE supports a no-gap and with-interruption measurement of the target SSB based on the UE supporting a ‘ncsg’ value for a ‘gapIndicationIntra-r17’ parameter in a ‘NeedForNCSG-IntraFreq-r17’ information element (IE) for serving cells on a same band as indicated by the UE being capable to periodically change the actual BW of the UE within the CBW to include the bandwidth of the target SSB.

16. The apparatus of claim 15, wherein the one or more processors is further configured to:
decode, from signaling received from the UE, UE capability information comprising a value for the ‘gapIndicationIntra-r17’ parameter in the ‘NeedForNCSG-IntraFreq-r17’ IE, wherein the value is different from the ‘ncsg’ value; and
ignore the value of the ‘gapIndicationIntra-r17’ parameter when the one or more processors is further configured to determine that the UE supports no-gap and with-interruption measurement of the target SSB.

17. The apparatus of claim 1, wherein the one or more processors is further configured to:
decode, from signaling received from the UE, a dynamic dependency indication parameter comprising a value, wherein,
the one or more processors is further configured to determine the UE supports a no-gap and with-interruption measurement for the SSB further based on whether the UE is configured with at least one of (i) a number of active serving cells, (ii) a number of configured serving cells comprising active and deactivated serving cells, or (iii) a number of bands with configured serving cells, that do not exceed the value of the dynamic dependency indication parameter.

18. The apparatus of claim 17, wherein the value of the dynamic dependency indication parameter is indicated per UE or per frequency range (FR).

19. The apparatus of claim 1, wherein the one or more processors is further configured to:
decode, from signaling received from the UE, an information element (IE) in a Radio Resource Control (RRC) reconfiguration complete message comprising an indication related to the UE supporting being capable to periodically change the actual BW of the UE within the CBW to include the bandwidth of the target SSB, wherein,
the one or more processors is further configured to determine that the UE supports a no-gap and with-interruption measurement for the target SSB further based on the indication.

20. The apparatus of claim 1, wherein the apparatus is preconfigured with a parameter comprising a value, wherein,
the one or more processors is further configured to determine that the UE supports a no-gap and with-interruption measurement for the target SSB further based on whether the UE is configured with one of (i) a number of active serving cells, (ii) a number of configured serving cells comprising active and deactivated serving cells, or (iii) a number of bands with configured serving cells, that do not exceed the value of the parameter.

21-63. (canceled)
